(19) United States
(12) Patent Application Publication
(10) Pub. No.: US 2024/0160689 A1
(43) Pub. Date: May 16, 2024

(54) METHOD FOR OPTIMIZING CONVOLUTION OPERATION OF SYSTEM ON CHIP AND RELATED PRODUCT

(71) Applicant: Shanghai Cambricon Information Technology Co., Ltd, Shanghai (CN)

(72) Inventors: Zheng SUN, Shanghai (CN); Ming LI, Shanghai (CN); Wenjuan DAI, Shanghai (CN); Zhize CHEN, Shanghai (CN); Guang JIANG, Shanghai (CN); Xin YU, Shanghai (CN)

(21) Appl. No.: 18/284,694

(22) PCT Filed: Apr. 14, 2022
(86) PCT No.: PCT/CN2022/086814

§ 371 Date: Sep. 28, 2023

(30) Foreign Application Priority Data
Apr. 16, 2021 (CN) 202110414138.6

(51) Int. Cl. G06F 17/15

(52) U.S. Cl. CPC G06F 17/153

(57) ABSTRACT

A method is for optimizing a convolution operation of an on-chip system and related products. The on-chip system is included in a computing processing apparatus of a combined processing apparatus. The computing processing apparatus includes one or a plurality of integrated circuit apparatuses. The combined processing apparatus further includes an interface apparatus and other processing apparatus. The computing processing apparatus interacts with other processing apparatus to jointly complete a computing operation specified by a user. The combined processing apparatus further includes a storage apparatus. The storage apparatus is connected to the apparatus and other processing apparatus, respectively. The storage apparatus is configured to store data of the apparatus and other processing apparatus.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/CN2022/086814 filed on Apr. 14, 2022, which claims priority to the benefit of Chinese Patent Application No. 202110414138.6 filed in the Chinese Intellectual Property Office on Apr. 16, 2021, the entire contents of which are incorporated herein by reference.

### BACKGROUND

### 1. Technical Field

The present disclosure generally relates to the field of data computing. More specifically, the present disclosure relates to a method for optimizing a convolution operation of an on-chip system, a device, and a computer-readable storage medium.

### 2. Background Art

In a currently rapidly developed artificial intelligence field, a large number of convolution operations are usually involved. In deep learning, a research hotspot in the field of artificial intelligence, in a convolution neural network (CNN) and its extended types of CNN networks or models, such as typical resenet, mobilenet, yolov3, OCR, conformer (which is convolution-augmented “transformer”) in the field of natural language processing (NLP), many computing tasks involve a large-scale convolution operation. It is well known that the larger the data volume and size involved in the convolution operation, the higher the requirement on computing power and memory access performance of a computing platform (especially an on-chip system).

In an existing convolution operation, a processor such as a central processing unit (CPU) or a graphics processing unit (GPU) is usually used. However, due to the limitation of the capacity of the internal memory resources of the processor, the large amount of data operation caused by the large-scale convolution operation will result in frequent and large amount of data interaction between the on-chip system of the processor and an off-chip system (including an external memory). Due to the limited bandwidth of the input/output (“I/O”) bus between the processor and the external memory, a serious I/O bottleneck problem will be caused, and the resulting data transmission delay may greatly reduce the efficiency of parallel operations. Further, not only the limited bandwidth of the I/O bus will become the bottleneck of system performance, but also the large amount of I/O access between the processor and the external memory will bring adverse effects on computing and power consumption overheads. Therefore, how to optimize data access in a convolution operation becomes a very important means to improve performance of the convolution operation.

### SUMMARY

To at least address the technical issues mentioned above, the present disclosure provides a solution that optimizes a convolution operation of an on-chip system. Specifically, the present disclosure provides an optimal method for determining the splitting of input feature map tensor data and convolution kernel tensor data in the convolution operation. By using an optimal splitting method to split the previous two types of tensor data, the convolution operation disclosed in the present disclosure significantly reduces the amount of data transmission with an external memory, thereby minimizing the I/O bottleneck caused by the limited bandwidth of the bus, and then improving the efficiency of the convolution operation. In view of this, the present disclosure provides the foregoing solution in following aspects.

A first aspect of the present disclosure discloses a method for optimizing a convolution operation of an on-chip system. The method is implemented by one or a plurality of processors and includes: receiving tensor information of an input feature map tensor and a convolution kernel tensor that are to be split to perform the convolution operation, where the input feature map tensor and the convolution kernel tensor are multi-dimensional tensor data, and the tensor information at least includes size information of the input feature map tensor in each of its dimensions, size information of the convolution kernel tensor in each of its dimensions, and respective data sizes of the input feature map tensor and the convolution kernel tensor; constructing a cost function at least based on the tensor information and splitting coefficients, where the cost function is used to determine the cost of transferring tensor data between the on-chip system and an off-chip system to perform the convolution operation on the on-chip system, and the splitting coefficients are used to split the input feature map tensor and the convolution kernel tensor on respective one or more dimensions of the input feature map tensor and the convolution kernel tensor; and determining coefficient values of the splitting coefficients by minimizing the cost function to use the coefficient values to perform splitting on the respective one or more dimensions of the input feature map tensor and the convolution kernel tensor.

A second aspect of the present disclosure discloses a device for optimizing a convolution operation of an on-chip system, including: a processor; and a memory, on which a program instruction for optimizing a convolution operation of an on-chip system is stored, where when the program instruction is performed by the processor, the device performs the above method.

A third aspect of the present disclosure discloses a computer-readable storage medium, on which a program instruction for optimizing a convolution operation of an on-chip system is stored, where when the program instruction is performed by a processor, the above method is performed.

A fourth aspect of the present disclosure discloses an on-chip system for performing a convolution operation, including: a plurality of master computing units, where each master computing unit includes a plurality of computing sub-units, where each computing sub-unit is configured to perform a convolution operation of corresponding tensor data; a plurality of caches, configured to cache tensor data and results associated with a convolution operation, where the on-chip system is configured to perform a convolution operation between an input feature map tensor block and a convolution kernel tensor block, and the input feature map tensor block and the convolution kernel tensor block are obtained by splitting according to the coefficient values of the splitting coefficients of the above method.

A fifth aspect of the present disclosure discloses an integrated circuit apparatus, including the above on-chip system.

A sixth aspect of the present disclosure discloses a board card, including the above integrated circuit apparatus.

By using the method, device, and computer-readable storage medium disclosed above, an optimal splitting method for tensor data participating in a convolution operation may be determined, thereby significantly optimizing the convolution operation. Specifically, by constructing the cost function of the cost caused by transferring the tensor data between the on-chip system and the off-chip system and aiming to minimize the cost function, the solution of the present disclosure selects optimal splitting coefficients for splitting two types of tensor data. Therefore, through a convolution operation performed based on the optimal splitting coefficients, the solution of the present disclosure may make full use of on-chip resources of the on-chip system and reduce I/O data interaction with an external memory of the off-chip system, thus achieving efficient parallel execution of data transfer and the convolution operation.

Further, by performing multi-dimensional splitting of large tensor data in combination with a hardware architecture, the solution of the present disclosure also simplifies the complexity of the convolution operation and supports a convolution operation of super-large tensor data. In some embodiments, through the above cost function, the solution of the present disclosure may also select an optimal convolution algorithm from a plurality of candidate convolution algorithms to realize the efficient execution of the convolution operation.

### BRIEF DESCRIPTION OF DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 is a principle diagram of a convolution operation performed by a convolution layer in a neural network model.

FIG. 2 is a schematic block diagram of splitting multi-dimensional tensor in a convolution operation according to an embodiment of the present disclosure.

FIG. 3 is a flowchart of a method for optimizing a convolution operation of an on-chip system according to an embodiment of the present disclosure.

FIG. 4A to FIG. 4C are schematic diagrams of splitting an input feature map tensor and a convolution kernel tensor according to a plurality of embodiments of the present disclosure.

FIG. 5 is an architecture diagram of a memory access operation in a convolution operation according to an embodiment of the present disclosure.

FIG. 6 is a schematic architecture diagram of L2 cache shown in FIG. 5.

FIG. 7 is a schematic architecture diagram of L1 cache shown in FIG. 5.

FIG. 8 is a schematic diagram of a tensor block according to a plurality of embodiments of the present disclosure.

FIG. 9 is a structural diagram of an on-chip system that performs a convolution operation according to an embodiment of the present disclosure.

FIG. 10 is a flowchart of a method for selecting an optimal convolution algorithm according to an embodiment of the present disclosure.

FIG. 11 is a structural diagram of a combined processing apparatus according to an embodiment of the present disclosure.

FIG. 12 is a structural diagram of a board card according to an embodiment of the present disclosure.

### DETAILED DESCRIPTION OF EMBODIMENTS

Technical solutions in embodiments of the present disclosure will be described clearly and completely hereinafter in combination with drawings in the embodiments of the present disclosure. Obviously, the description below is intended to discuss a plurality of exemplary embodiments of the present disclosure and is not intended to be an exhaustive description of the embodiments of the present disclosure. All other embodiments obtained by those skilled in the art based on the embodiments of the present disclosure without creative efforts shall fall within the scope of protection of the present disclosure. In addition, although the present disclosure describes one or more different solutions in a plurality of embodiments, those skilled in the art may, in accordance with the teachings of the present disclosure, think of appropriate combinations of one or more of the foregoing solutions to form new solutions to achieve further technical effects, and these new solutions still fall within the scope of protection disclosed in the present disclosure.

According to the research of the inventor of the present disclosure, an input feature map tensor and a convolution kernel tensor, in whatever form they are split to perform a convolution operation, do not significantly change the total computing amount of multiplication and addition. However, when the above tensor data is split in a particular form, the amount of I/O between an on-chip system performing the convolution operation and an off-chip system may be changed significantly. In view of this, optimizing the amount of I/O between the on-chip system and the off-chip system to determine an optimal splitting method becomes a key to reduce the delay of the convolution operation and improve the performance of the convolution operation.

Considering the above situation, in order to improve I/O memory access performance of the convolution operation (especially the convolution operation in the convolution layer in the neural network model) and operation efficiency of the convolution operation and significantly reduce the cost of the operation, the present disclosure proposes a solution for optimizing a convolution operation, involving determining values of splitting coefficients for splitting large multi-dimensional tensor data. In an exemplary scenario of the present disclosure, the multi-dimensional tensor data may be an input feature map and a convolution kernel that perform a convolution operation. In an implementation scenario, the input feature map and the convolution kernel may be four-dimensional tensor data. In another implementation scenario, the input feature map and the convolution kernel may be three-dimensional tensor data.

For a convolution operation with a large data scale and multiple dimensions, the present disclosure proposes to respectively split a large input feature map tensor and a large convolution kernel tensor in a plurality of different dimensions, and regard each block obtained after splitting (which is a “tensor block” in the context of the present disclosure) as an element of the multi-dimensional tensor, and then perform the convolution operation based on the element. By such splitting operations, a large-size convolution operation may be converted into a relatively small convolution operation between tensor blocks. As such, the solution of the present disclosure may make the convolution operation with the large data scale and multiple dimensions more clear and explicit, so that the convolution operation may be greatly simplified. Further, considering that storage resources and computing resources of an on-chip system of a computing device are very limited, block (“tensor block”) convolution is also an important means to solve the convolution operation problem of the on-chip system. For example, by splitting a large multi-dimensional tensor according to on-chip resources (such as storage resources and computing resources) of the on-chip system in advance, the on-chip system may only convolve two tensor blocks obtained after splitting each time, so that the convolution operation may be adapted to limited operation resources. In order to facilitate the understanding of the convolution operation disclosed in the present disclosure, FIG. 1 is taken as an example to illustrate the convolution operation performed by the convolution layer in the neural network.

FIG. 1 is a principle diagram of a convolution operation performed by a convolution layer in a neural network model. As shown in the figure, the convolution layer in the neural network model may convolve an input feature map with a convolution kernel and then perform feature extraction to obtain an output feature map.

An input feature map with a size of 6×6×3 is exemplarily shown in the figure, where the input feature map represents three feature maps (which constitute a three-dimensional tensor with a size of 6×6×3) with a size of 6×6, which represent three different features. In this embodiment, a width W of the input feature map is 6, and a height H of the input feature map is also 6. A count of input feature maps may also be called an input channel count C. For example, there are three input feature maps in the figure, and the three feature maps are also called three feature channels.

FIG. 1 exemplarily shows a convolution kernel (or called a filter) with a size of 2×3-3×3, where the convolution kernel represents two convolution kernels (which are two three-dimensional tensors with a size of 3×3×3) with a size of 3×3×3. Each convolution kernel has three different convolution kernels with a size of 3×3, which correspond to three different feature maps of the input feature map. A count of three-dimensional convolution kernels may be called an output channel count Co. In this embodiment, the Co is 2. In each three-dimensional convolution kernel, a count of two-dimensional convolution kernels may be called an input channel count C, which is the same as the channel count of the input feature maps. Each two-dimensional convolution kernel has a corresponding width K_{w} and a corresponding height Kₕ, and in this embodiment, both the K_{w} and the Kₕ are 3.

Further, as shown in the figure, a convolution result of the input feature map and the convolution kernel is output as two feature maps with a size of 4×4. Here, a convolution result of the input feature map and the below three-dimensional convolution kernel is to obtain the below one output feature map with a size of 4.4. A value at each position in the output feature map is obtained by performing a two-dimensional convolution operation on a corresponding block of each input feature map and a corresponding convolution kernel and then summing corresponding results. For example, the figure shows that a value at (0, 0) in the below output feature map is obtained by performing a two-dimensional convolution operation on a block framed by a black cube in the input feature map and the below three-dimensional convolution kernel to obtain three values and then summing the three values. In order to obtain outputs of other positions, a position of the convolution kernel may be moved in the input feature map, which is a sliding operation of the convolution kernel along the input feature map. In the example of the figure, a convolution stride (Sx, Sy) is (1,1), and a value at (0,1) or (1,0) in the below output feature map may be obtained respectively by performing the convolution operation after moving the convolution kernel to the right one grid in the horizontal direction (width direction) or down one grid in the vertical direction (height direction).

It may be known from the above description that, in one convolution layer of the neural network model, there is one group of input feature map, totally including H×W×C pieces of information, where H is a height of the input feature map, W is a width of the input feature map, and C is a count of input feature maps, which is also called an input channel count. There are C×Co convolution kernels with a size of Kₕ×K_{w} in the convolution layer, where C is an input channel count, Co is a count of output feature maps (or an output channel count), Kₙ is a height of the convolution kernel, and K_{w} is a width of the convolution kernel. There are Ho×Wo×Co pieces of information in the output feature map, where Ho is a height of the output feature map. Wo is a width of the output feature map, and Co is an output channel count. Besides, during a convolution operation, a convolution stride (Sx, Sy) is also involved, and a size of the convolution stride may affect a size of the output feature map.

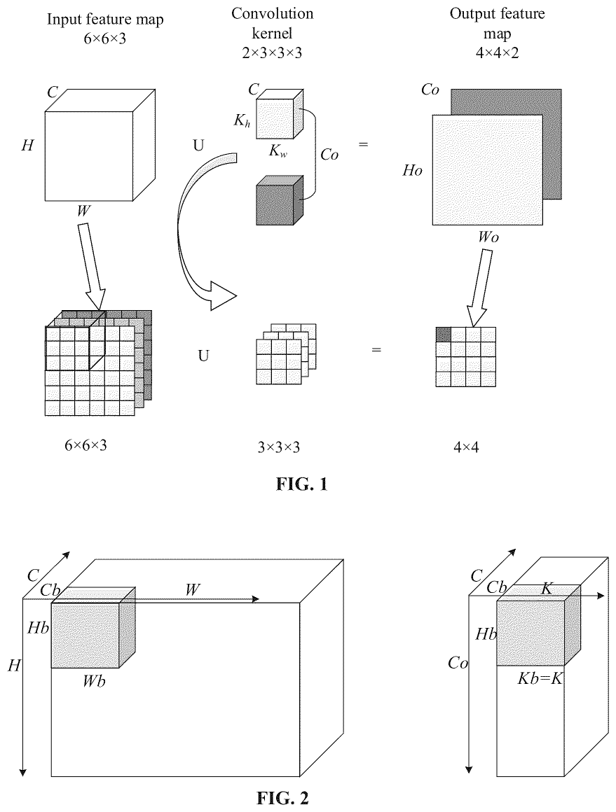

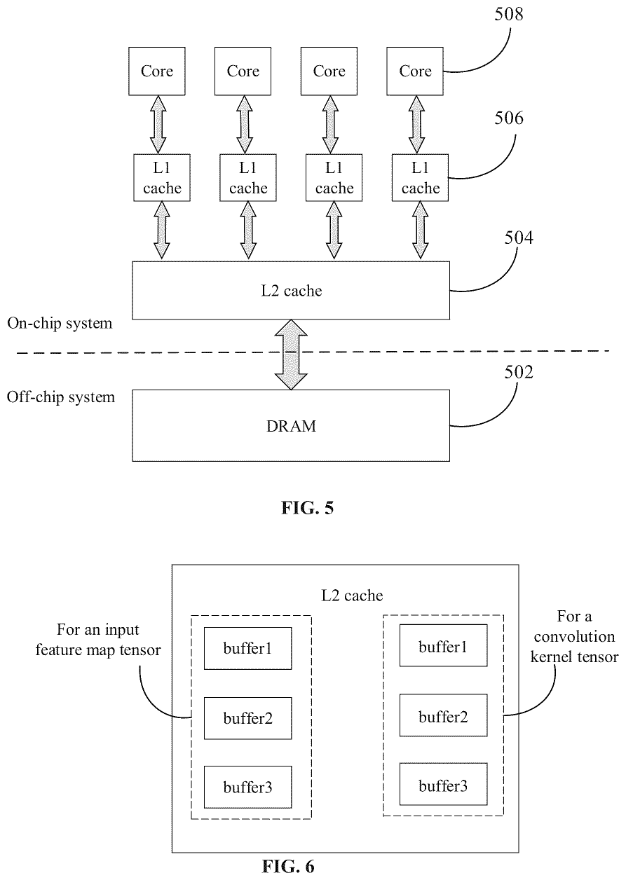

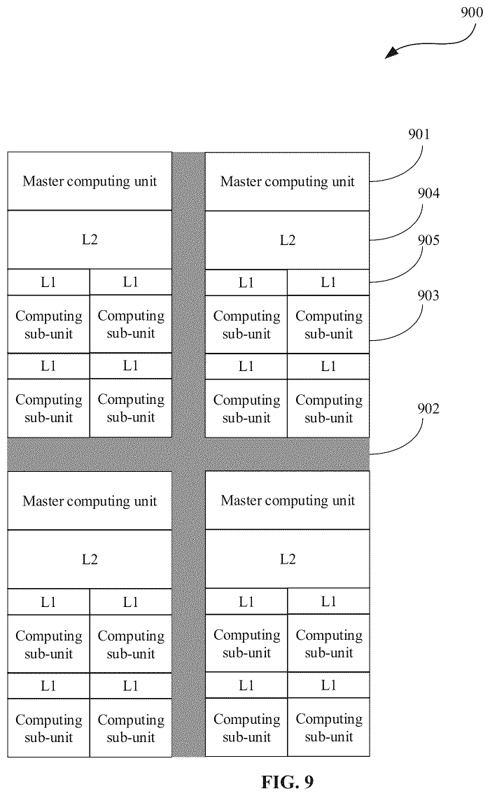

The convolution operation in the neural network model is described by example in combination with FIG. 1. It should be understood that the input feature map and the convolution kernel are shown as three-dimensional tensor data for illustrative purposes only. However, in a scenario to which the present disclosure solution may be applied, tensor data may have more dimensions, such as four dimensions (such as N dimension discussed later) or more than four dimensions, and a size of the tensor data is larger, and for example, the tensor data has a relatively larger height and a relatively larger width. Further, in order to accelerate the convolution operation of the neural network model, the present disclosure also proposes to arrange a plurality of operation units on the on-chip system to perform parallel operations, where each operation unit may perform a convolution operation between split tensor blocks (which are tensor sub-blocks in the context of the present disclosure). In an implementation scenario, the above operation unit may include, for example, a computing sub-unit “Core” shown in FIG. 5 or a master computing unit and a computing sub-unit shown in FIG. 9. For example, each master computing unit may include a plurality of (such as 4 in FIG. 9) convolution-dedicated computing units (or convolution units) to perform convolution operations on further split tensor sub-blocks (which are atomic tensor blocks in the context of the present disclosure), thereby improving computing speed and efficiency of the convolution operation. The following will detail a splitting operation of the present disclosure in combination with FIG. 2.

FIG. 2 is a schematic block diagram of splitting a multi-dimensional tensor in a convolution operation according to an embodiment of the present disclosure. When a plurality of input feature maps are considered, the convolution operation described above in combination with FIG. 1 may be expressed by a following computing formula (1):

$${Y}_{n , h , w , {c}_{o}} = {\sum }_{i = 0}^{C} {\sum }_{j = 0}^{{k}_{w}} {\sum }_{k = 0}^{{k}_{h}} {X}_{n , h + k , w + j , i} \cdot {W}_{{c}_{o} , k , j , i} \qquad ( 1 )$$

Similar to the symbols shown in FIG. 1, in the formula (1), X represents an input feature map tensor, which may be a four-dimensional tensor of N*C*H*W or N*H*W*C, where the N dimension represents a count or batch size of input feature maps, the H dimension is a height of the input feature maps, the W dimension is a width of the input feature maps, and the C dimension is a total channel count of the input feature maps. Further, W (which is not the width “W” in the above) in the formula (1) represents a convolution kernel, whose format may be Co*C*Kₕ*K_{w} or Co*Kₕ*K_{w}*C, where the Kₕ dimension is a height of the convolution kernel, the K_{w} dimension is a width of the convolution kernel, the C dimension is a channel count of input feature maps, and the Co dimension is a channel count of output feature maps. Similar to X, Y in the formula (1) represents an output feature map tensor, which may be a four-dimensional tensor of N*Co*H*W or N*H*W*Co. Unless expressly stated to the contrary, the same symbols used in the below will have the same physical meaning as described herein.

It may be known from the above formula (1) that the convolution operation may be regarded as a multiplication operation of two pieces of tensor data from the input feature map and convolution kernel and weaken the C dimension (contraction is performed on the C dimension), thus ultimately “assigning” the Co dimension of the convolution kernel to the input. Such an operation is a decoupling and coupling process, and a function of the convolution kernel is closer to a transformation or mapping on some dimension of the input feature map tensor.

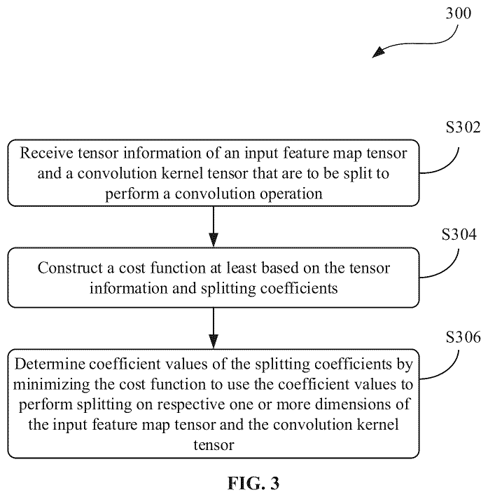

As mentioned before, for an arbitrarily large input feature map and convolution kernel, due to the limitation of on-chip storage resources, the present disclosure proposes to split the input feature map and convolution kernel in one or more dimensions respectively, so that split input feature map and convolution kernel tensor blocks are exactly operated on the on-chip system, and on-chip and off-chip memory access performance of tensor data is improved significantly. As shown in the left part of FIG. 2, an input feature map tensor may be split along the W, H, and C dimensions into input feature map tensor blocks indicated by subscripts “b” in the figure. Similarly, as shown in the right part of FIG. 2, a convolution kernel tensor may be split along the C, Co, and convolution kernel (K in the figure) dimensions into convolution kernel tensor blocks indicated by subscripts “b” in the figure. By splitting the input feature map tensor and convolution kernel tensor in different dimensions in this way, input feature map tensor blocks and convolution kernel tensor blocks represented by gray blocks in the left and right part of FIG. 2 may be obtained; in other words, the tensor block is a “base shape” of tensor data suitable for the convolution operation on the on-chip system after considering resources of the on-chip system. To determine such a base shape, the present disclosure proposes a method flowchart shown in FIG. 3.

FIG. 3 is a flowchart of a method 300 for optimizing a convolution operation of an on-chip system according to an embodiment of the present disclosure. As is well known to those skilled in the art, the on-chip system is usually a complete system integrated on a single chip. This system may generally include various units, such as a system-on-chip control logic unit, a microprocessor/micro-controller central processing unit (CPU) kernel unit, an embedded memory unit, and an interface unit for communicating with an off-chip system. In the context of the present disclosure, the on-chip system may be a system on chip (SoC) that supports a convolution operation, including a plurality of master computing units for performing a convolution operation and a memory for storing convolution tensor data and convolution operation results. In an implementation scenario, the plurality of master computing units may be connected in turn to form a data transfer loop, and each master computing unit may include a plurality of computing sub-units, thereby realizing primary tensor block splitting at the master computing unit level and secondary tensor sub-block splitting at the computing sub-unit level, which constitute a multilevel tensor splitting operation. Based on this, it may be understood that splitting coefficients of the present disclosure are also related to a count of master computing units of the on-chip system and a count of computing sub-units contained in each master computing unit. The exemplary connection and arrangement of the master computing units and the computing sub-units are described in detail later in conjunction with drawings.

Further, according to different application scenarios, the method 300 may be performed by different action agents. In a scenario, the method 300 may be implemented by one or a plurality of processors. In a heterogeneous system with a general-purpose CPU and a graphics dedicated processor GPU, the method 300 may also be performed by the general-purpose CPU, and results obtained (which are coefficient values of the splitting coefficients of the present disclosure) may then be used by the GPU for the splitting and convolution operations of the tensor data of the on-chip system.

As shown in FIG. 3, in step S302, tensor information of an input feature map tensor and a convolution kernel tensor that are to be split to perform a convolution operation is received. As mentioned before, the input feature map tensor and the convolution kernel tensor may be multi-dimensional tensor data, such as three-dimensional or four-dimensional tensor data discussed earlier in combination with FIG. 1 and FIG. 2. Based on this, the above tensor information may at least include size information of the input feature map tensor in each of its dimensions, size information of the convolution kernel tensor in each of its dimensions, and respective data sizes of the input feature map tensor and the convolution kernel tensor. According to different scenarios, the size information may be in bits or bytes.

Next, in step S304, a cost function may be constructed at least based on the tensor information and splitting coefficients. As mentioned before, it is necessary to consider data access performance both off-chip and on-chip when the convolution operation is performed in the on-chip system Based on this, the present disclosure provides a cost function for determining the cost of transferring tensor data between the on-chip system and an off-chip system to perform the convolution operation on the on-chip system, so as to find splitting coefficients for splitting the tensor data by minimizing the cost function. Here, the splitting coefficients may be used to split the input feature map tensor and the convolution kernel tensor on respective one or more dimensions of the input feature map tensor and the convolution kernel tensor. In an implementation scenario, when both the input feature map tensor and the convolution kernel tensor are three-dimensional tensor data, the splitting coefficients are used to split the input feature map tensor and the convolution kernel tensor in one or more of three dimensions. In another implementation dimension, when both the input feature map tensor and the convolution kernel tensor are four-dimensional tensor data, the splitting coefficients are used to split the input feature map tensor and the convolution kernel tensor in one or more of four dimensions.

In an implementation scenario, the splitting coefficients of the input feature map tensor and the convolution kernel tensor may be N_{b}*H_{b}*W_{b}*C_{b} and C_{b}*K*K_{w}*Co_{b} respectively, where N_{b}, H_{b}, W_{b}, C_{b}, and Co_{b} represent splitting coefficients corresponding to N, H, W, C, and Co dimensions, respectively. Based on this, the method of the present disclosure may further include constructing the cost function at least based on the tensor information and the splitting coefficients N_{b}, H_{b}, W_{b}, C_{b}, and Co_{b}. It should be understood that the splitting coefficients disclosed herein are only exemplary, not restrictive, and may be adjusted appropriately according to the scale and size of the tensor data. For example, in some scenarios, when the N dimension has been reasonably set without requiring splitting, the splitting coefficient N_{b} of the N dimension is not required to be determined. For example, when the C dimension is too small, splitting in the C dimension may also be ignored.

In another implementation scenario, constructing the cost function further includes constructing the cost function based on bandwidth utilization coefficients of leading dimensions of the input feature map tensor and the convolution kernel tensor. The leading dimension of the input feature map tensor is one of the H_{b}, W_{b}, and C_{b}, and the input feature map tensor is arranged (or laid out) on the off-chip system in terms of its leading dimension. The leading dimension of the convolution kernel tensor is one of the C_{b} or Co_{b}, and the convolution kernel tensor is arranged on the off-chip system in terms of its leading dimension. Here, the bandwidth utilization coefficient equals to a ratio between an equivalent bandwidth when tensor blocks are loaded from the off-chip system at a predetermined data length and a total bandwidth between the on-chip system and the off-chip system.

Based on the above description, minimizing (expressed in “min”) the cost function may be expressed in following forms according to different application scenarios and requirements:

$$\begin{matrix}min ( ⌈ \frac{H}{{H}_{b}} ⌉ ⌈ \frac{W}{{W}_{b}} ⌉ \times {Weight}_{size} + ⌈ \frac{C}{{Co}_{b}} ⌉ \times [ ( ⌈ \frac{H}{{H}_{b}} ⌉ - 1 ) ( {k}_{h} - 1 ) + ( ⌈ \frac{W}{{W}_{b}} ⌉ - 1 ) ( {k}_{w} - 1 ) ] \times C + ⌈ \frac{C}{{Co}_{b}} ⌉ \times {Input}_{size} ) ; & ( 2 ) \\ min ( ⌈ \frac{H}{{H}_{b}} ⌉ ⌈ \frac{W}{{W}_{b}} ⌉ \times {Weight}_{size} + ⌈ \frac{C}{{Co}_{b}} ⌉ \times {Input}_{size} ) ; & ( 3 ) \\ min ( ⌈ \frac{N}{{N}_{b}} ⌉ ⌈ \frac{H}{{H}_{b}} ⌉ ⌈ \frac{W}{{W}_{b}} ⌉ \times {Weight}_{size} + ⌈ \frac{C}{{Co}_{b}} ⌉ \times {Input}_{size} ) ; & ( 4 ) \\ min ( ⌈ \frac{N}{{N}_{b}} ⌉ ⌈ \frac{H}{{H}_{b}} ⌉ ⌈ \frac{W}{{W}_{b}} ⌉ \times {Weight}_{size} \times γ ( {C}_{b} ) + ⌈ \frac{C}{{Co}_{b}} ⌉ \times {Input}_{size} \times γ ( {C}_{b} ) ) . & ( 5 )\end{matrix}$$

In the formulas (2)˜(5) above, the same symbols have the same physical meanings. Further, “┌ ┐” represents a rounding up operation, Weight_{size} represents a data size of a convolution kernel, and Input_{size} represents a data size of an input feature map. Here, the data size may be in bytes or bits. In addition, γ( ) represents a bandwidth utilization coefficient, which equals to a ratio between an equivalent bandwidth when tensor blocks are loaded from the off-chip system at a predetermined data length and a total bandwidth between the on-chip system and the off-chip system. Taking γ(C_{b}) in the formula as an example, it represents a ratio between an equivalent bandwidth of C_{b} as a leading dimension and a full bandwidth, where the equivalent bandwidth of C_{b} refers to the inverse of the time taken to load to-be-operated tensor data segment by segment with a data length of C_{b}. Further, the full bandwidth may refer to a total bandwidth of data transfer between the on-chip system and the off-chip system, which approximately equals to the inverse of the time taken to continuously load the to-be-operated tensor data from the off-chip system to the on-chip system in one go.

In the above formula (2),

$$“ ⌈ \frac{C}{{Co}_{b}} ⌉ \times [ ( ⌈ \frac{H}{{H}_{b}} ⌉ - 1 ) ( {k}_{h} - 1 ) + ( ⌈ \frac{W}{{W}_{b}} ⌉ - 1 ) ( {k}_{w} - 1 ) ] \times C ”$$

is the cost term caused by the overlap of boundary data when splitting is performed along the plane composed of the H and W dimensions. Specifically, when splitting is performed on the plane composed of the H and W dimensions, loading the data at the boundary after the splitting will produce “overlap”, which is caused by the convolution operation of the convolution kernel in a sliding fashion on the HW plane. Based on this, each time input feature map tensor data is loaded, more data is required to be loaded in the H and W dimensions. Here, the size of loading the tensor data is associated with the size of the convolution kernel. For example, when the input feature map tensor has the base shape (H_{b}, W_{b}, C_{b}) described in FIG. 2, the size of the tensor data required to be loaded is (H_{b}+k_{b}−1, W_{b}+k_{w}−1, C_{b}). Here, kₕ represents a height of the convolution kernel, k_{w} represents a width of the convolution kernel, and the base shape is the shape into which the present disclosure is intended to split the tensor data, which is the tensor block.

When the cost term in the above formula (2) is ignored, the cost function expressed in the formula (3) may be obtained. Further, when splitting in the N dimension is considered, the cost term in the formula (3) may introduce

$$⌈ \frac{N}{{N}_{b}} ⌉ ,$$

thus obtaining the cost function expressed in the formula (4). In an implementation scenario, when the above bandwidth utilization coefficient is further considered, “γ(C_{b})” may be introduced in the cost term, thus obtaining the cost function expressed in the formula (5).

After the cost function is constructed in the above, in step S306, coefficient values of the splitting coefficients are determined by minimizing the cost function to use the coefficient values to perform splitting on respective one or more dimensions of the input feature map tensor and the convolution kernel tensor.

In an embodiment, coefficients values of the above splitting coefficients N_{b}, H_{b}, W_{b}, C_{b}, and Co_{b} are determined by minimizing the cost function to split the input feature map tensor and the convolution kernel tensor into corresponding tensor blocks respectively based on the coefficients values.

In an embodiment, in determining the coefficients values of the splitting coefficients by minimizing the cost function, the method of the present disclosure further includes creating search space used for minimizing the cost function, so that the coefficients values of the splitting coefficients are determined by using the search space. In an implementation scenario, creating the search space used for minimizing the cost function may include dividing a high-speed cache (also called a cache memory or a cache, such as 504 and 506 shown in FIG. 5) of the on-chip system; and creating the search space according to a division result. In the solution of the present disclosure, the cache is configured to store split tensor blocks and convolution results obtained by performing a convolution operation on the split tensor blocks. Correspondingly, the off-chip system may be configured with a global memory, which may transfer various types of data including tensor blocks to the on-chip cache through an I/O interface. In a scenario, the global memory may be a dynamic random access memory (such as “DRAM” shown by 502 in FIG. 5), such as a double rate synchronous (“DDR”) dynamic random access memory.

In an implementation scenario, the above on-chip system may include multiple levels of caches, and the method of the present disclosure may include: creating search sub-space associated with each level of cache according to a predetermined convolution algorithm that is used to perform a convolution operation. In an embodiment, the predetermined convolution algorithm may include multiple levels of “cannon” algorithms. Based on this, in a scenario, the above multiple levels of caches include a first level of cache and a second level of cache, so that the search space may include first search sub-space associated with the first level of cache and second search sub-space associated with the second level of cache. In this situation, the method of the present disclosure further includes: creating the first search sub-space according to settings of a plurality of first high-speed buffers in the first level of cache, where the plurality of first high-speed buffers are configured to store tensor sub-blocks obtained by splitting the tensor block and intermediate operation results obtained by performing the convolution operation on the tensor sub-blocks.

Further, the method of the present disclosure may create the second search sub-space according to settings of a plurality of second high-speed buffers in the second level of cache, where the plurality of second high-speed buffers are configured to store atomic tensor blocks obtained by splitting the tensor sub-blocks and intermediate operation results obtained by performing the convolution operation on the atomic tensor blocks. Thus, in a scenario using a “two-level” cannon algorithm, a “first-level” cannon algorithm involves tensor sub-blocks, and the tensor sub-blocks may be obtained by further splitting a tensor block split by using coefficient values of splitting coefficients of the present disclosure. Correspondingly, a “second-level” cannon algorithm involves atomic tensor blocks, and the atomic tensor blocks may be obtained by further splitting the tensor sub-blocks.

In an embodiment, determining the coefficient values of the splitting coefficients may include determining search strides used to search the search space. In an implementation scenario, the search strides may include search strides Δn, Δh, Δw, Δc, and Δco associated with the N, H, W, C, and Co dimensions respectively. After determining the above search strides, a search algorithm may be used to search in the search space created above with the search strides to finally determine specific coefficient values of the splitting coefficients for minimizing the cost function.

In an embodiment, in order to determine specific values of the search strides above, the above tensor information of the present disclosure further includes the number of master computing units (shown in FIG. 9) of the on-chip system that participate in the convolution operation, the number of processing sub-units (such as “Core” shown in FIG. 5) in each master computing unit, and a data volume size of loading from the off-chip system and achieving the highest bandwidth utilization. By using the foregoing information items included in the tensor information, the method of the present disclosure proposes to determine the search strides at least based on the count of the master computing units, the count of the processing sub-units, and the data volume size.

Additively or alternatively, in an embodiment, in order to determine the specific values of the above search strides, the above tensor information of the present disclosure further includes storage formats and data layout information of the input feature map tensor and the convolution kernel tensor in the off-chip system, where the storage formats include data storage in a corresponding leading dimension, and the data layout information includes placement information of a tensor in each dimension. For example, in an embodiment of the present disclosure, dimensions of the input feature map tensor may be represented as N*H*W*C when the input feature map tensor has four dimensions, which also represents the order in which the data is stored or placed in the memory. It may be understood that, although multi-dimensional data has multiple dimensions, since the layout of the memory is always one-dimensional, there is a correspondence between the multi-dimensional data and the storage order in the memory. The multi-dimensional data is usually allocated in continuous storage space. In other words, the multi-dimensional data may be extended in one dimension and stored in the memory in sequence. For example, the data may be stored sequentially in a low-dimension (such as the C dimension in the N*H*W*C)-first fashion. Adjacent dimensions refer to dimensions that are right next to each other in dimension information representations of multi-dimensional data. For example, W and C are adjacent. The adjacent dimensions may also be called continuous dimensions.

The method for optimizing the convolution operation of the on-chip system of the present disclosure is described above in combination with FIG. 3. By using the method disclosed in the present disclosure, the complexity of the convolution operation of the on-chip system may be simplified, and the bottleneck of IO interaction between the on-chip system and the off-chip system may be overcome, thereby improving overall performance of the on-chip system performing the convolution operation.

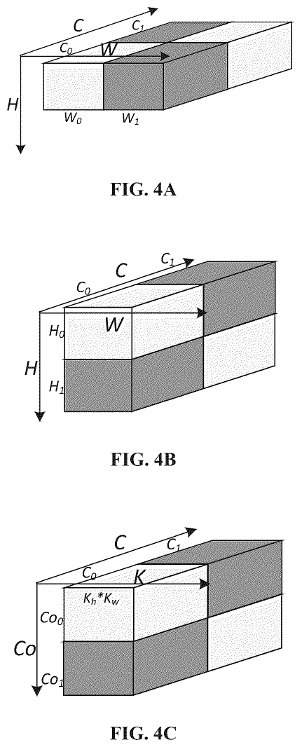

FIG. 4A to FIG. 4C are schematic diagrams of splitting an input feature map tensor and a convolution kernel tensor according to a plurality of embodiments of the present disclosure. In the process of splitting tensor data, when a convolution kernel is not considered to be split, the convolution kernel may be regarded as one dimension, C dimension is regarded as one dimension, Co dimension is regarded as one dimension, and input H dimension and W dimension are regarded as one separate dimension respectively. Based on this setting, base shapes after splitting are shown respectively in FIG. 4A to FIG. 4C. Specifically, splitting dimensions shown in the figure are H*W*C and Co*K*C, where K represents a convolution kernel. Here, an input feature map tensor is represented by only three dimensions H*W*C; in other words, by default, N dimension is not required to be split or has been split appropriately. When there are four master computing units in an on-chip system, at this time, a convolution kernel tensor is mainly considered to be split on the Co and C dimensions (as shown in FIG. 4C. After taking into account a convolution operation after splitting on the master computing unit, the input feature map tensor is split on one of the H or W dimension. For example, as shown in FIG. 4A, the H dimension is fixed, and the input feature map tensor is split on the W dimension; or as shown in FIG. 4B, the W dimension is fixed, and the input feature map tensor is split on the H dimension.

FIG. 5 is an architecture diagram of a memory access operation in a convolution operation according to an embodiment of the present disclosure. As shown in FIG. 5, a hardware architecture disclosed in the present disclosure may include an on-chip system and an off-chip system. For simplicity purposes, only a global memory DRAM 502 is shown by example in the off-chip system. During the loading of tensor blocks in performing the convolution operation, the DRAM may transfer data with a L2 cache 504 through a double data rate (DDR) interface. For example, a tensor block that is to perform the convolution operation is split into tensor sub-blocks and then loaded into the L2 cache 504. In an embodiment, the L2 cache 504 may be a shared memory of the on-chip system, which is shared by a plurality of master computing units.

Further, the L2 cache 504 may transfer data with a plurality of L caches 506, so that atomic tensor blocks obtained by splitting the tensor sub-blocks again are transferred to the L1 caches 506 accordingly. In the context of the present disclosure, an atomic tensor block may be viewed as a minimum tensor block unit that performs a convolution operation supported by a computing sub-unit. Then, a computing core (“Core”) 508 (which is the computing sub-unit in the context of the present disclosure) may acquire the atomic tensor blocks from the L1 cache 506 to perform convolution operations of the atomic tensor blocks. In this scenario, the L1 cache 506 may be viewed as a private memory for each computing core 508. According to the solution of the present disclosure, the plurality of computing sub-units may form a computing master unit. For example, four computing cores 508 in FIG. 5 may form one computing master unit of the present disclosure.

Based on the above description and as shown in FIG. 5, those skilled in the art may understand that the on-chip system disclosed herein may include multiple levels of caches. Therefore, for example, the L2 cache 504 shown in FIG. 5 may be viewed as a first level of cache, and the L1 cache 506 may be viewed as a second level of cache. Based on this, as mentioned before, search sub-space associated with each level of cache is created according to a predetermined convolution algorithm that is used to perform a convolution operation. For this example, corresponding first search sub-space and second search sub-space are created according to the first level of cache (such as the L2 cache 504) and the second level of cache (such as the L1 cache 506). As mentioned above, by creating search space (which is one or more constraints on splitting coefficients) associated with storage space, the solution of the present disclosure may search in this search space with the search strides until optimal values of the splitting coefficients are determined.

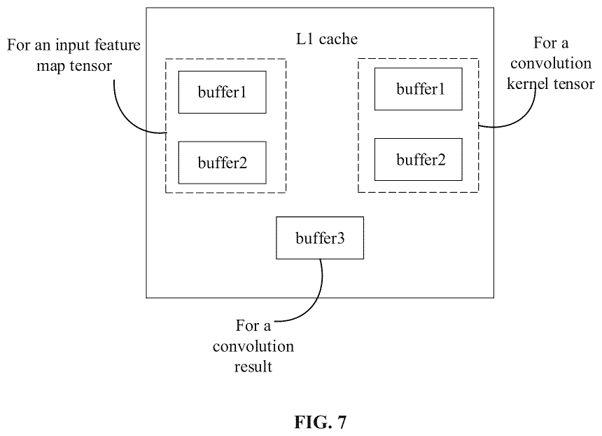

In order to better understand the search space of the present disclosure, FIG. 6 and FIG. 7 are used as examples to discuss creating the search space of the present disclosure based on two levels of caches. As shown in FIG. 6 and FIG. 7, the two levels of caches are a L2 cache and a L1 cache (which are the L2 cache and the L1 cache shown in FIG. 5) respectively, and the following uses a two-level “cannon” algorithm to speed up a convolution operation.

First, three separate high-speed buffers may be set up on the L2 cache 504 for an input feature map tensor and a convolution kernel tensor respectively, which are a buffer1, a buffer2, and a buffer3 shown in FIG. 6. For use purposes, the buffer1 may be configured to receive tensor data (such as tensor sub-blocks) sent by other master computing units, the buffer2 may load tensor data from a global memory (such as the DRAM shown in FIG. 3), and the buffer3 is provided to a master computing unit for transferring tensor data (such as atomic tensor blocks) to the L1 cache to enable a computing sub-unit to perform real-time computing and save intermediate results of a convolution operation in the L1 cache. Based on the foregoing arrangement and considering splitting the tensor data into P₁ pieces in the HW plane (composed of H and W dimensions), C, and Co dimensions respectively according to base shapes and a first-level cannon algorithm, thus splitting the tensor data into P₁ tensor sub-blocks, in this case, a constraint (which is the search space corresponding to the cost function in the formula (3)) on the L2 cache may be expressed by a following formula (6):

$$dw ( {Input}_{size} ) \times \frac{{H}_{b} {W}_{b}}{{P}_{1}} \frac{{C}_{b}}{{P}_{1}} + dw ( {Weight}_{size} ) \times \frac{{Co}_{b}}{{P}_{1}} \frac{{C}_{b}}{{P}_{1}} < \frac{{Space}_{smemory}}{3} , \qquad ( 6 )$$

where

dew(X) represents a size (in bits or bytes) of a minimum data element in X, and Space_{smemory} represents storage capacity of the L2 cache 504. According to different implementations,

$$“ \frac{{H}_{b} {W}_{b}}{{P}_{1}} ”$$

in the formula (6) may represent the splitting of P₁ pieces along one of H or W dimensions in the HW plane. The above formula (6) shows the above first search sub-space, and the present disclosure searches for suitable H_{b}, W_{b}, C_{b}, and Co_{b}, which are coefficient values of splitting coefficients, when the formula (6) is satisfied. In addition, it should be noted that the above “P₁” is also related to the setup of the master computing unit of the on-chip system. For example, when the on-chip system includes four master computing units, at this time, a value of “P₁” is 2, which means that each tensor block is respectively split into two pieces in the HW plane, C, and Co dimensions, so that one tensor block is split into four tensor sub-blocks. Similarly, when the on-chip system includes nine master computing units, at this time, a value of “P₁” is 3, which means that each tensor block is respectively split into three pieces in the above dimensions, so that one tensor block is split into nine tensor sub-blocks.

After the above operation of determining the first search sub-space, the present disclosure sets a plurality of buffers on the L1 cache according to a “two-level” cannon algorithm to determine the second search sub-space of the present disclosure. Therefore, the present disclosure proposes that two separate buffers, which are a buffer1 and a buffer2 shown in FIG. 7, may be set up on the L1 cache for an input feature map tensor and a convolution kernel tensor, respectively, to be used for pipeline operations of a convolution operation of atomic tensor blocks (which are obtained by splitting tensor sub-blocks). In terms of pipeline operations, the buffer1 and the buffer2 may alternately receive the atomic tensor blocks and participate in the convolution operation. Next, one separate buffer is set up for convolution results that reside on the L1 cache, which is a buffer3 shown in FIG. 7, to be used for storing intermediate results obtained by performing a convolution operation between atomic tensor blocks.

Similar to the determination of the above first search sub-space, based on the first-level cannon algorithm (which is to split a tensor block into tensor sub-blocks in different dimensions), then, according to a second-level cannon algorithm, each of the above split tensor sub-blocks is further split into P₀ pieces in the HW plane, C, and Co dimensions respectively to obtain the atomic tensor blocks of the present disclosure. Based on this, a constraint on the L1 cache may be expressed by a following formula (7):

$$dw ( {Input}_{size} ) \times \frac{{H}_{b} {W}_{b}}{{P}_{1}} \frac{{C}_{b}}{{P}_{1}} + dw ( {Weight}_{size} ) \times \frac{{K}_{h} {K}_{w} {Co}_{b}}{{P}_{0} {P}_{1}} \frac{{C}_{b}}{{P}_{0} {P}_{1}} + dw ( C ) \times \frac{{H}_{b} {W}_{b}}{{P}_{0} {P}_{1}} \frac{{C}_{ob}}{{P}_{0} {P}_{1}} < \frac{{Space}_{smemory}}{2} . \qquad ( 7 )$$

In the formula (7), dw(C) represents a size (in bits or bytes) of a minimum data element in convolution operation results, and Space_{pmemory} represents storage capacity of the L1 cache 506. Further, when

$$“ \frac{{H}_{b} {W}_{b}}{{P}_{1}} ”$$

in the above formula (6) represents the splitting of P₁ pieces along the H dimension in the HW plane,

$$“ \frac{{H}_{b} {W}_{b}}{{P}_{0} {P}_{1}} ”$$

in the formula (7) represents the splitting of P₀ pieces along the W dimension in the HW plane. Correspondingly, when

$$“ \frac{{H}_{b} {W}_{b}}{{P}_{1}} ”$$

in the above formula (6) represents the splitting of P₁ pieces along the W dimension in the HW plane,

$$“ \frac{{H}_{b} {W}_{b}}{{P}_{0} {P}_{1}} ”$$

in the formula (7) represents the splitting of P₀ pieces along the H dimension in the HW plane.

It may be understood that the above formula (7) shows the above second search sub-space, and the present disclosure searches for suitable H_{b}, W_{b}, C_{b}, and Co_{b} when both the formula (6) and the formula (7) are satisfied, thus obtaining suitable splitting coefficient values. In addition, it should be noted that similar to the above “P₁” “P” is also related to the setup of the computing sub-unit of the on-chip system. For example, when each master computing unit of the on-chip system includes four computing sub-units, at this time, a value of “P₀” is 2, which means that each tensor sub-block is split into two pieces in the HW plane, C, and Co dimensions respectively, so that one tensor sub-block is split into four atomic tensor blocks. Similarly, when each master computing unit includes nine computing sub-units, at this time, a value of “P₀” is 3, which means that each tensor sub-block is split into three pieces in the HW plane, C, and Co dimensions respectively, so that one tensor sub-block is split into nine atomic tensor blocks.

The above details the search space of the present disclosure in combination with FIG. 6 and FIG. 7. It is required to be understood that the above description is only illustrative and not limited, and that those skilled in the art, based on the teachings of this disclosure, may also think of creating matched search space according to the storage arrangement and data volume size of the on-chip system. For example, taking the cost function represented by the formula (5) as an example, the following search space may be set according to the storage arrangement of the on-chip system:

$$\begin{matrix}{N}_{bx} {H}_{bx} {W}_{bx} ( {Co}_{bx} {bw}_{output} + {C}_{b} {bw}_{input} ) < MAX\_NRAM \_SIZE & ( 8 ) \\ {K}_{h} {K}_{w} {Co}_{bx} {C}_{b} {bw}_{filter} < MAX\_WRAM \_SIZE & ( 9 ) \\ 3 {N}_{b} \frac{{H}_{b} {W}_{b}}{2} \frac{{C}_{b}}{2} {bw}_{input} + 3 {K}_{h} {K}_{w} \frac{{Co}_{b}}{2} \frac{{C}_{b}}{2} {bw}_{filter} < MAX\_SRAM \_SIZE & ( 10 )\end{matrix}$$

In the above formula, bwᵢₙₚᵤₜ/bw_{filter}/bwₒᵤₜₚᵤₜ represents a bit width (for example, in bits or bytes) of an input feature map tensor/convolution kernel tensor/output feature map tensor respectively. Further, MAX_NRAM_SIZE in the above formula represents maximum storage space available on a neuron storage unit (Neuron RAM, NRAM), where the NRAM may be configured to store both the input feature map tensor and the output feature map tensor; MAX_WRAM_SIZE represents maximum storage space available on a weight storage unit (Weight RAM, WRAM), where the WRAM may be configured to store the convolution kernel tensor; MAX_SRAM_SIZE represents maximum storage space for on-chip storage of tensor sub-blocks.

It may be known that the above formulas (8), (9), and (10) represent constraints on the NRAM, WRAM, and SRAM, respectively, which are the search space described in the present disclosure, where the formula (10) is equivalent to the first search space created for the L2 cache, and “the formula (8)+the formula (9)” is equivalent to the second search space created for the L1 cache. “2” in the denominator of the formula (10) is determined by a splitting method after considering a cannon algorithm among master computing units. Correspondingly, Cb in the formulas (8) and (9) is not divided by 2 to make ping-pang pipelining for atomic tensors of input feature maps and convolution kernels of computing sub-units. Specifically, when only the Co_{b} or HW plane is split in the master computing unit and C_{b} is not split, the C_{b} may be C_{b}/2 in the master computing unit after being split by the cannon algorithm. In order to realize pipelining in the computing sub-unit, storage space of “(C_{b}/2)×2” is also required, so the C_{b} in the formulas (8) and (9) is formed.

A subscript “bx” in the above formula represents a computable dimension on a single computing sub-unit. This computable dimension is related to task splitting under the master computing unit. For example, when the Co dimension is split in the master computing unit, Co_{b}, is represented as a quarter of (Co_{b}/2), and other dimensions and base shapes within the master computing unit remain unchanged; and when the N dimension is split in the master computing unit, N_{b}, is a quarter of N_{b}. Similarly, the same processing may be performed on the H_{b}, and W_{b}. It may be seen that for internal splitting of a single master computing unit, those skilled in the art may perform the splitting according to practical applications. For example, the splitting may be performed in the N dimension or Co dimension to avoid again splitting in the H and W dimensions. It is required to be noted that the splitting is performed again in the Co dimension, at this time, a size of the Co_{b} is required to be as large as possible.

The search strides for searching in the search space disclosed in the present disclosure are described below. As mentioned above, the search strides of the present disclosure may be associated with the storage formats and data layout of the input feature map tensor and the convolution kernel tensor in the off-chip system, the number of the master computing units of the on-chip system, the number of the computing sub-units in the master computing unit, and the data volume size of loading from the off-chip system and achieving the highest bandwidth utilization.

In terms of the storage and data layout of the input feature map tensor and the convolution kernel tensor of the present disclosure, the tensors may be arranged in data layout formats N*C*H*W (the N dimension is the highest dimension, and the W dimension is the lowest dimension) and Co*K_{H}*K_{W}*C (the Co dimension is the highest dimension, and the C dimension is the lowest dimension) described earlier, respectively. Alternatively, the input feature map tensor and the convolution kernel tensor may be arranged in data layout formats N*H*W*C (the N dimension is the highest dimension, and the C dimension is the lowest dimension) and C*K_{H}*K_{W}*Co (the C dimension is the highest dimension, and the Co dimension is the lowest dimension), respectively. Further, off-chip storage of tensor data may be performed by row priority (row-major order). Taking N=1, C=64, H=5, W=4, and row-major order as examples, since the W dimension is the lowest dimension, so four elements are stored first row by row along the W dimension, and data layout of C=0 is completed after five rows of elements are stored. The elements are stored in this manner until data layout of C=63 is completed.

When it is considered that the L2 cache or the L1 cache loads data from the DDR each time, it is assumed that the highest bandwidth utilization (which is the segment-by-segment loading described above) is achieved when a data size of one load is “L”. In an implementation scenario, the “L” may have a data length (for example, in bytes) equal to a “cacheline” or an integer multiple of that cacheline.

Considering the above described content and the on-chip splitting of each dimension, in an application scenario, when a two-level cannon algorithm is used to perform a convolution operation, following example solution expressions for search strides Δn, Δh, Δw, Δc, and Δco in the dimensions N, H, W, C, and Co may be obtained, where scm(X,Y) represents finding the least common multiple of X and Y:

In the row-major order, “memory layout” of the input feature map tensor is N*C*H*W (the N dimension is the highest dimension), and memory layout of the convolution kernel tensor is Co*K_{H}*K_{W}*C (the Co dimension is the highest dimension).

Δn=1 (considering that the N dimension is not split in the on-chip system)

Δh=P₁ (considering that the tensor is split into P₁ pieces in the H dimension in the first-level cannon algorithm)

Δw=scm(P₀, L) (considering that the tensor is split into P₀ pieces in the W dimension in the second-level cannon algorithm)

Δc=scm(P₁×P₀, L) (considering that the C dimension of the convolution kernel tensor is in the lowest dimension, so a search stride is a multiple of L; and the C dimension is split, so the search stride is also a multiple of P₁×P₀)

Δco=P₁×P₀ (considering that the Co dimension of the convolution kernel tensor is in the highest dimension, and the Co dimension is split)

In an implementation scenario, when the above memory layout of the convolution kernel tensor in this embodiment is C*K_{H}*K_{W}*Co (the Co dimension is the lowest dimension), at this time, since the Co dimension is in the lowest dimension, Δco=L; since the C dimension is in the highest dimension, Δc=P₁×P₀.

In the row-major order, when the “memory layout” is N*H*W*C (the N dimension is the highest dimension), the memory layout of the convolution kernel tensor is C*K_{H}*K_{W}*Co (the Co dimension is the lowest dimension).

Δn=1 (considering that the N dimension is not split in the on-chip system)

Δh=P₀ (considering that the tensor is split into P₀ pieces in the H dimension in the second-level cannon algorithm)

Δw=P₁ (considering that the tensor is split into P₁ pieces in the W dimension in the first-level cannon algorithm)

Δc=scm(P₁×P₀, L) (considering that the C dimension of the input feature map tensor is in the lowest dimension, so a search stride is a multiple of L; and the C dimension is split, so the search stride is also a multiple of P₁×P₀)

Δco=P₁×P₀ (considering that the Co dimension of the convolution kernel tensor is in the lowest dimension, and the Co dimension is split)

In an implementation scenario, when the above memory layout of the convolution kernel tensor in this embodiment is Co*K_{H}*K_{W}*C, at this time, the C dimension is the lowest dimension, and the Co dimension is in the highest dimension, so Δc=scm(P₁×P₀, L), Δco=P₁×P₀.

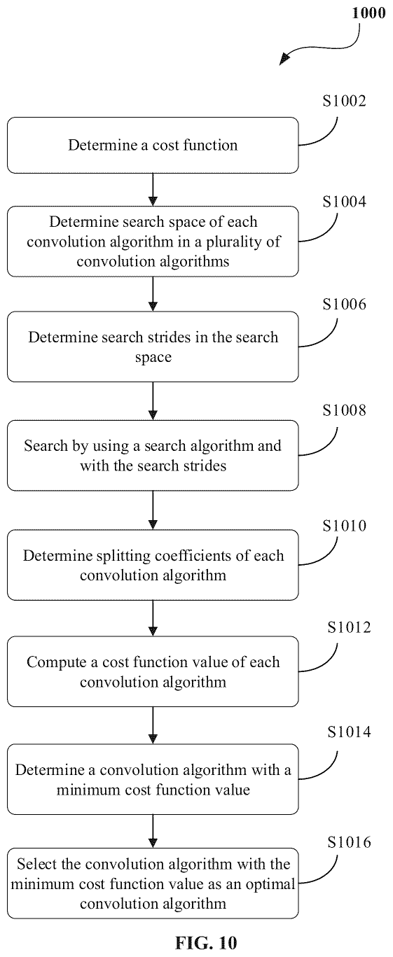

Taking the two-level cannon algorithm as an example, the above example describes the process of determining the search stride of the present disclosure. It may be understood that the above description is only exemplary and not restrictive, and those skilled in the art may choose to use different convolution algorithms according to the above description, thus obtaining corresponding search strides. The different convolution algorithms may be obtained, for example, by different splitting methods. Taking the above cannon algorithm as an example, when those skilled in the art perform the cannon algorithm only at the master computing unit level and not at the computing sub-unit level (for example, only the first-level cannon algorithm is performed), then a new convolution algorithm is formed, which is different from the two-level cannon algorithm in this embodiment, thus creating new search space and determining a new search stride based on this. When there are a plurality of new convolution algorithms mentioned above, the present disclosure also proposes an algorithm selection solution, which will be described in detail later in combination with FIG. 10.

Further, based on the above description, those skilled in the art may also understand that the present disclosure may determine the search stride based on one or more of following factors. The factors, for example, may include a count of master computing units participating in a convolution operation (which, for example, may be related to a size of the “P₁” value above), a count of computing sub-units in each of the master computing units (which, for example, may be related to a size of the “P₀” value above), a data size of loading from the off-chip system (such as “DDR”) and achieving the highest bandwidth utilization (which, for example, may be related to the “L” value above), and storage formats and data layout of tensor data.

After acquiring the above search stride, the method of the present disclosure may use a suitable search algorithm to search optimal splitting coefficients N_{b}, H_{b}, W_{b}, C_{b}, and Co_{b} in the search space with the search stride determined above to minimize a value of the cost function of the present disclosure (which is “minimizing” described in the context of the disclosure). The search algorithms usable in the present disclosure may include, but are not limited to, a global search, a neighborhood search, a genetic algorithm, and other optimization algorithms.

For exemplary purposes only, the following shows that final splitting coefficients of tensor blocks are acquired through the global search algorithm in the form of pseudo-code.

Global Search:

| | |
|---|---|
| 1: | Initialization:s⁰=(N,H,W,C,Co,N_{b}=Δn,H_{b}=Δh,W_{b}=Δw,C_{b}=Δc, andCo_{b}=Δco); |
| 2: | costₘᵢₙ=cost(s⁰) |
| 3: | for N_{b} ′ in range(Δn, Δn, N) do |
| 4: | for H_{b} ′ in range(Δh, Δh, H) do |
| 5: | for W_{b} ′ in range(Δw, Δw, W) do |
| 6: | for C_{b} ′ in range(Δc, Δc, C) do |
| 7: | for Co_{b} ′ in range(Δco, Δco, Cob) do |
| 8: | s¹=(N,H,W,C,Co, N_{b} ′,H_{b} ′,W_{b} ′,C_{b} ′,Co_{b} ′); |
| 9: | if s¹ϵU1∩U2 and costₘᵢₙ>cost(s¹) then |
| 10: | s⁰=s¹ |
| 11: | costₘᵢₙ =cost(s¹) |
| 12: | end if |
| 13: | end for |
| 14: | end for |
| 15: | end for |
| 16: | end for |
| 17: | end for |
| 18: | Return: s⁰ |

Here, U1 in the above exemplary pseudo-code is a collection (which is the second search sub-space in the context of the present disclosure, as shown in the formula (7)) that satisfies constraints of the L1 cache, and U2 is a collection (which is the first search sub-space in the context of the present disclosure, as shown in the formula (6)) that satisfies constraints of the L2 cache.

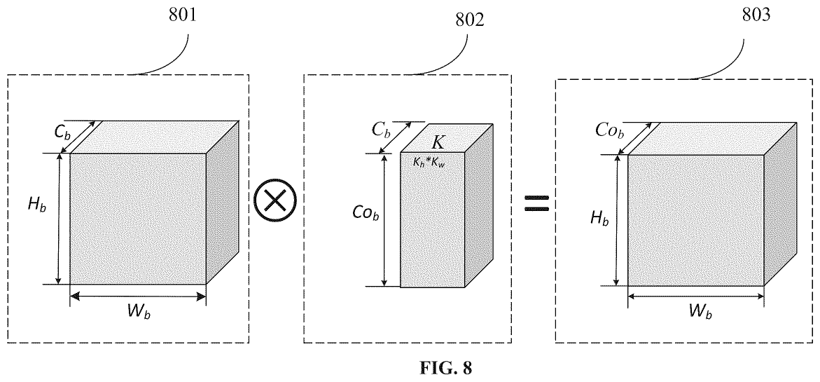

FIG. 8 is a schematic diagram of tensor blocks according to a plurality of embodiments of the present disclosure. As shown in the figure, after the optimal splitting coefficients N_{b}, H_{b}, W_{b}, C_{b}, and Co_{b} of the present disclosure are determined as above, an input feature map tensor may be split into input feature map tensor blocks as shown in 801. Further, a convolution kernel tensor may be split into convolution kernel tensor blocks as shown in 802. Based on a convolution operation between the input feature map tensor blocks and the convolution kernel tensor blocks, as referred to by “⊗” in the figure, output feature map tensor blocks as shown in 803 may be obtained. It is required to be noted that for the sake of simplification and illustration, the splitting of tensor data in the N dimension is not shown here. As mentioned above, according to the solution of the present disclosure, it is also possible to perform splitting in the N dimension in Nb to further optimize on-chip and off-chip data interaction. Further, after a size of a tensor block is determined, those skilled in the art may additionally split the tensor block according to the chosen convolution algorithm to make the tensor block be suitable for the convolution operation of the system-on-chip. For example, in the example of the present disclosure, after tensor blocks are acquired by using splitting coefficient values determined according to a two-level cannon algorithm, the tensor blocks may be further split according to splitting rules of the two-level cannon algorithm to obtain tensor sub-blocks and atomic tensor blocks described above in the present disclosure, so that a convolution operation between the atomic tensor blocks may be performed at the computing sub-unit.

The method for optimizing the convolution operation of the on-chip system of the present disclosure is described above in combination with FIGS. 1-8. By using the method of the present disclosure, optimal splitting coefficients for splitting an input feature map tensor and a convolution kernel tensor may be determined. Thus, when two types of tensor data mentioned above are split by using the optimal splitting coefficients for the convolution operation, the cost in terms of data transmission (such as I/O overhead) is minimal. Based on this, a hardware platform that performs a convolution operation will perform a convolution operation in a more efficient and less computationally expensive way.

FIG. 9 is a structural diagram of an on-chip system that performs a convolution operation according to an embodiment of the present disclosure. It may be understood that an on-chip system 900 shown in FIG. 9 may be a concrete implementation of the on-chip system shown in FIG. 5, so the description of the on-chip system shown in FIG. 5 is also applicable to the description here.

As shown in FIG. 9, the on-chip system 900 may include a plurality of master computing units (“Cluster”) 901, four of which are exemplified in the figure. These four master computing units 901 may be interconnected via a crossbar 902. In an embodiment, as shown in the figure, each master computing unit may include a plurality of computing sub-unit 903 (which are “Core” shown in FIG. 5), four of which are exemplified in the figure. Further, a L2 cache 904 and a L1 cache 905 are shown, where the L2 cache 904 may be shared by a plurality of master computing units of the on-chip system and may be configured for data interaction with an off-chip system; and the L1 cache 905 may be regarded as a private memory of each computing sub-unit. In a convolution operation scenario, the computing sub-unit of the on-chip system may perform a convolution operation on split tensor data (such as the atomic tensor blocks in the context of the present disclosure), so that convolution operation results may be obtained. In an implementation scenario, intermediate operation results obtained by performing the convolution operation on the atomic tensor blocks by the computing sub-unit may reside on the L1 cache as a partial sum. Moreover, for example, after a final computing result is obtained by cyclic operations in the C dimension, the final computing result is passed to an off-chip memory, such as a DDR.

The optimization solution and application in combination with the hardware architecture of the present disclosure are detailed above in combination with the drawings, and then the following will discuss an algorithm selection solution of the present disclosure. Here, the algorithm selection solution is to select an optimal algorithm from a plurality of algorithms suitable for convolution operations to perform a convolution operation. In particular, it is assumed that there are a plurality of candidate algorithms that implement convolution operations. Since the number of these algorithms is finite, finite algorithm space F={f₀, f1, f₂, . . . , fₙ} may be formed. Next, a global optimization goal may be set as the following in the algorithm space:

$${min}_{{f}_{i} ⊂ F} [ cost ( {f}_{i} , N , H , W , C , Co ; {N}_{b} , {H}_{b} , {W}_{b} , {C}_{b} , {Co}_{b} ) ] , \qquad ( 11 )$$

where

N, H, W, C, Co; N_{b}, H_{b}, W_{b}, C_{b}, Co_{b} have the same meaning as corresponding terms in the previous plurality of expressions. Based on the above scenario, the following details how to select an optimal convolution algorithm in combination with FIG. 10.

FIG. 10 is a flowchart of a method 1000 for selecting an optimal convolution algorithm according to an embodiment of the present disclosure. As shown in FIG. 10, in step S1002, a cost function is determined, where the determination method for the cost function may be the method described above in combination with FIG. 3, which is not repeated here.

Next, in step S1004, search space of each convolution algorithm in a plurality of convolution algorithms (which are the above plurality of “candidate algorithms”) is determined, and in step S1006, search strides in the search space are determined. The determination methods for the search space and the search strides may refer to the aforementioned description and will not be repeated here. Next, in step S1008, search is performed by using a search algorithm (such as the above global algorithm, neighborhood search, or genetic algorithm) and with the determined search strides, thus, in step S1010, determining splitting coefficients corresponding to each convolution algorithm (such as splitting coefficients N_{bi}, H_{bi}, W_{bi}, C_{bi} and CO_{bi} for an i-th algorithm). Next, in step S1012, a cost function value of each convolution algorithm is computed, and in step S1014, a convolution algorithm with a minimum cost function value is determined. Therefore, in step S1016, the convolution algorithm with the minimum cost function value is selected as an optimal convolution algorithm, and corresponding splitting coefficients of the convolution algorithm are used to split multi-dimensional tensor data.

Through the above algorithm selection solution of the present disclosure, an optimal algorithm may be selected from a plurality of algorithms for convolution operations. The selected algorithm may implement a convolution operation of tensor blocks with minimum operation cost, thus improving operation efficiency of the convolution operation and reducing computing cost. Further, when the above optimal algorithm is used to perform a convolution operation on the on-chip system, resource usage of the on-chip system is maximized, thus taking full advantage of computing power of the on-chip system.

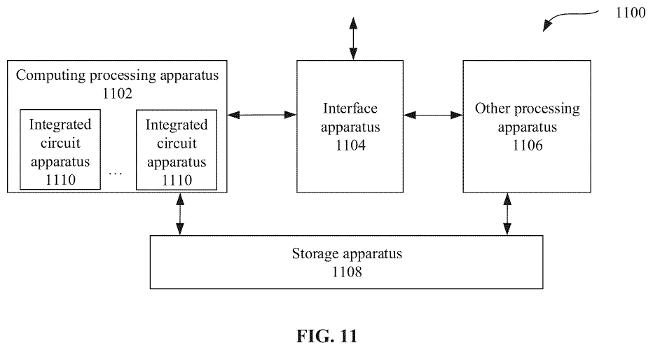

FIG. 11 is a structural diagram of a combined processing apparatus 1100 according to an embodiment of the present disclosure. As shown in FIG. 11, the combined processing apparatus 1100 includes a computing processing apparatus 1102, an interface apparatus 1104, other processing apparatus 1106, and a storage apparatus 1108. According to different application scenarios, the computing processing apparatus may include one or a plurality of integrated circuit apparatuses 1110. The integrated circuit apparatus may include the on-chip system described in the context of the present disclosure, and the on-chip system is configured to perform a convolution operation of tensor data. In an implementation scenario, the tensor data may include an input feature map tensor and a convolution kernel tensor. Further, through the optimization solution discussed in the context of the present disclosure, the above input feature map tensor and convolution kernel tensor may be split based on splitting coefficients, thus obtaining tensor blocks suitable for a convolution operation performed by an on-chip system.

In different embodiments, the computing processing apparatus of the present disclosure may be configured to perform an operation specified by a user, such as the convolution operation of the present disclosure. In an exemplary application, the computing processing apparatus may be implemented as (or may include) a single-core artificial intelligence processor or a multi-core artificial intelligence processor. Similarly, one or a plurality of computing apparatuses included in the computing processing apparatus may be implemented as an artificial intelligence processor core or a partial hardware structure of the artificial intelligence processor core. If the plurality of computing apparatuses are implemented as artificial intelligence processor cores or partial hardware structures of the artificial intelligence processor cores, the computing processing apparatus of the present disclosure may be regarded as having a single-core structure or an isomorphic multi-core structure.

In an exemplary operation, the computing processing apparatus of the present disclosure may interact with other processing apparatus through the interface apparatus, so as to jointly complete the operation specified by the user. According to different implementations, other processing apparatuses of the present disclosure may include one or more types of general and/or dedicated processors, including a central processing unit (CPU), a graphics processing unit (GPU), an artificial intelligence processor, and the like. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, the number of the processors may be determined according to actual requirements. As described above, with respect to the computing processing apparatus of the present disclosure only, the computing processing apparatus of the present disclosure may be regarded as having the single-core structure or the isomorphic multi-core structure. However, when the computing processing apparatus and other processing apparatus are considered together, both the computing processing apparatus and other processing apparatus may be regarded as forming a heterogeneous multi-core structure.

In one or a plurality of embodiments, other processing apparatus may serve as an interface between the computing processing apparatus (which may be embodied as an artificial intelligence operation apparatus such as a neural network operation apparatus) of the present disclosure and external data and controls. Other processing apparatus may perform basic controls that include but are not limited to moving data, and starting and/or stopping the computing apparatus. In other embodiments, other processing apparatus may also cooperate with the computing processing apparatus to jointly complete an operation task.

In one or a plurality of embodiments, the interface apparatus may be used to transfer data and a control instruction between the computing processing apparatus and other processing apparatus. For example, the computing processing apparatus may acquire input data from other processing apparatus via the interface apparatus and write the input data to an on-chip storage apparatus (or called a memory) of the computing processing apparatus. Further, the computing processing apparatus may acquire the control instruction from other processing apparatus via the interface apparatus and write the control instruction to an on-chip control cache of the computing processing apparatus. Alternatively or optionally, the interface apparatus may further read data in the storage apparatus of the computing processing apparatus and then transfer the data to other processing apparatus.

Additionally or optionally, the combined processing apparatus of the present disclosure may further include a storage apparatus. As shown in the figure, the storage apparatus is connected to the computing processing apparatus and other processing apparatus, respectively. In one or a plurality of embodiments, the storage apparatus may be used to save data of the computing processing apparatus and/or other processing apparatus. For example, the data may be data that may not be fully saved in the internal or the on-chip storage apparatus of the computing processing apparatus or other processing apparatus.

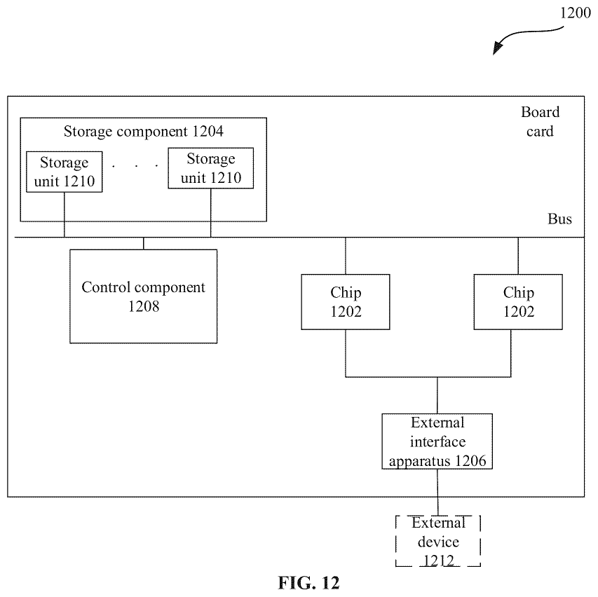

In some embodiments, the present disclosure also discloses a chip (such as a chip 1202 shown in FIG. 12). In an embodiment, the chip is a system on chip (SoC) and integrates one or a plurality of combined processing apparatuses shown in FIG. 11 and may be configured to perform a convolution operation between multi-dimensional tensor data. The chip may be connected to other related components through an external interface apparatus (such as an external interface apparatus 1206 shown in FIG. 12). The related components may be, for example, a camera, a monitor, a mouse, a keyboard, a network card, or a WIFI interface. In some application scenarios, the chip may integrate other processing units (such as a video codec) and/or an interface unit (such as a dynamic random access memory (DRAM) interface), and the like. In some embodiments, the present disclosure also discloses a chip package structure, including the chip. In some embodiments, the present disclosure discloses a board card, including the chip package structure above. The board card will be described in detail in combination with FIG. 12 below.

FIG. 12 is a schematic structural diagram of a board card 1200 according to an embodiment of the present disclosure. As shown in FIG. 12, the board card includes a storage component 1204 used for storing data. The storage component 1204 includes one or a plurality of storage units 1210. The storage component may be connected to and may transfer data to a control component 1208 and the chip 1202 through a bus. Further, the board card further includes an external interface apparatus 1206, which is configured to implement data relay or transfer between the chip (or the chip in the chip package structure) and an external device 1212 (such as a server or a computer, and the like). For example, to-be-processed data may be transferred from the external device to the chip through the external interface apparatus. For another example, a computing result of the chip may still be sent back to the external device through the external interface apparatus. According to different application scenarios, the external interface apparatus may have different interface forms. For example, the external interface apparatus may adopt a standard peripheral component interface express (PCIe) interface.

In one or a plurality of embodiments, the control component in the board card of the present disclosure may be configured to regulate and control a state of the chip. As such, in an application scenario, the control component may include a micro controller unit (MCU), which may be used to regulate and control a working state of the chip.

According to descriptions in combination with FIG. 11 and FIG. 12, those skilled in the art may understand that the present disclosure also discloses an electronic device or apparatus, which may include one or a plurality of the board cards, one or a plurality of the chips, and/or one or a plurality of the combined processing apparatuses. In an implementation scenario, the electronic device or apparatus may be configured to perform the convolution operation discussed in the context of the present disclosure and tensor data participating in the convolution operation is tensor block data obtained after splitting based on optimal splitting coefficients of the present disclosure.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. With respect to a connection between different units or components, the connection discussed above in combination with drawings may be direct or indirect coupling between the units or components. In some scenarios, the direct or indirect coupling involves a communication connection using an interface. The communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated.

In some implementation scenarios, the integrated unit may be implemented in the form of a software program unit. If the integrated unit is implemented in the form of the software program unit and sold or used as an independent product, the integrated unit may be stored in a computer-readable memory. Based on this, when the solution of the present disclosure is embodied in the form of a software product (such as a computer-readable storage medium), the software product may be stored in a memory. The software product may include several instructions used to enable a computer device (which may be a personal computer, a server, or a network device, and the like) to perform part or all of steps of the method of the embodiments of the present disclosure. The memory includes but is not limited to an USB, a flash disk, a read only memory (ROM), a random access memory (RAM), a mobile hard disk, a magnetic disk, or an optical disc, and other media that may store a program code.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), the ROM, and the RAM, and the like.

It should also be understood that any module, unit, component, server, computer, terminal or device performing an instruction of the embodiment of the present disclosure may include or access a computer-readable medium in another way, such as a storage medium, a computer storage medium, or a data storage device (removable and/or non-removable) such as a disk, a compact disc, or a magnetic tape. The computer storage medium may include volatile and non-volatile, movable and immovable media implemented by any method or technology used to store information, such as a computer-readable instruction, a data structure, a program module, or other data.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that terms used in the specification of the present disclosure are merely intended to describe a specific embodiment rather than to limit the present disclosure. As being used in the specification and the claims of the present disclosure, unless the context clearly indicates otherwise, singular forms such as “a”, “an” and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

Although the embodiments of the present disclosure are as above, the contents are only embodiments used to facilitate the understanding of the present disclosure, and are not intended to limit the scope and application scenarios of the present disclosure. Any skilled personnel in the technical field of the present disclosure may make any modification and change in the form and details of the embodiments without deviating from the spirit and scope disclosed by the present disclosure, but the scope of patent protection of the present disclosure shall still be defined in the scope of the attached claims.

1. A method for optimizing a convolution operation of an on-chip system, wherein the method is implemented by one or a plurality of processors, the method comprising:
receiving tensor information of an input feature map tensor and a convolution kernel tensor that are to be split to perform the convolution operation, wherein the input feature map tensor and the convolution kernel tensor are multi-dimensional tensor data, and the tensor information at least comprises size information of the input feature map tensor in each of its dimensions, size information of the convolution kernel tensor in each of its dimensions, and respective data sizes of the input feature map tensor and the convolution kernel tensor;
constructing a cost function at least based on the tensor information and splitting coefficients, wherein the cost function is used to determine the cost of transferring tensor data between the on-chip system and an off-chip system to perform the convolution operation on the on-chip system, and the splitting coefficients are used to split the input feature map tensor and the convolution kernel tensor on respective one or more dimensions of the input feature map tensor and the convolution kernel tensor; and
determining coefficient values of the splitting coefficients by minimizing the cost function to use the coefficient values to perform splitting on the respective one or more dimensions of the input feature map tensor and the convolution kernel tensor.

2. The method of claim 1, wherein both the input feature map tensor and the convolution kernel tensor are three-dimensional tensor data, or both the input feature map tensor and the convolution kernel tensor are four-dimensional tensor data, wherein when both the input feature map tensor and the convolution kernel tensor are the three-dimensional tensor data, the splitting coefficients are used to split the input feature map tensor and the convolution kernel tensor in one or more of three dimensions, and when both the input feature map tensor and the convolution kernel tensor are the four-dimensional tensor data, the splitting coefficients are used to split the input feature map tensor and the convolution kernel tensor in one or more of four dimensions.

3. The method of claim 2, wherein both the input feature map tensor and the convolution kernel tensor are the four-dimensional tensor data, wherein the input feature map tensor is a four-dimensional tensor of N*H*W*C, and the convolution kernel tensor is a four-dimensional tensor of C*Kh*Kw*Co, wherein the N dimension represents a count of input feature maps, the H dimension represents a height of the input feature maps, the W dimension represents a width of the input feature maps, the C dimension represents a channel count of the input feature maps, the Kh dimension represents a height of a convolution kernel, the Kw dimension represents a width of the convolution kernel, and the Co dimension represents a channel count of output feature maps.

4. The method of claim 3, wherein splitting coefficients of the input feature map tensor and the convolution kernel tensor are Nb*Hb*Wb*Cb and Cb*Kh*Kw*Cob, wherein the Nb, Hb, Wb, Cb, and Cob represent splitting coefficients corresponding to the N, H, W, C, and Co dimensions respectively, and
the method comprises:
constructing the cost function at least based on the tensor information and the splitting coefficients Nb, Hb, Wb, Cb, and Cob; and
determining coefficients values of the splitting coefficients Nb, Hb, Wb, Cb, and Cob by minimizing the cost function to split the input feature map tensor and the convolution kernel tensor into corresponding multiple tensor blocks respectively based on the coefficient values.

5. The method of claim 4, wherein the constructing of the cost function further comprises constructing the cost function based on bandwidth utilization coefficients of leading dimensions of the input feature map tensor and the convolution kernel tensor, wherein the leading dimension of the input feature map tensor is one of the Hb, Wb, and Cb and the input feature map tensor is arranged on the off-chip system in terms of its leading dimension, the leading dimension of the convolution kernel tensor is one of the Cb or Cob and the convolution kernel tensor is arranged on the off-chip system in terms of its leading dimension, and the bandwidth utilization coefficient equals to a ratio between an equivalent bandwidth when tensor blocks are loaded from the off-chip system at a predetermined data length and a total bandwidth between the on-chip system and the off-chip system.

6. The method of claim 1, wherein the determining the coefficient values of the splitting coefficients by minimizing the cost function comprises creating search space used for minimizing the cost function to determine the coefficients values of the splitting coefficients by using the search space.

7. The method of claim 6, wherein the creating of the search space used for minimizing the cost function comprises:
dividing a cache of the on-chip system; and
creating the search space according to a division result, wherein the cache is configured to store split tensor blocks and convolution results obtained by performing a convolution operation on the split tensor blocks.

8. The method of claim 7, wherein the on-chip system comprises multiple levels of caches, and the method comprises:
creating search sub-space associated with each level of cache according to a predetermined convolution algorithm that is used to perform a convolution operation.

9. The method of claim 8, wherein the multiple levels of caches comprise a first level of cache and a second level of cache, and the search space comprises first search sub-space and second search sub-space, and
the method comprises:
creating the first search sub-space according to settings of a plurality of first high-speed buffers in the first level of cache, wherein the plurality of first high-speed buffers are configured to store tensor sub-blocks obtained by splitting the tensor blocks and intermediate operation results obtained by performing a convolution operation on the tensor sub-blocks; and
creating the second search sub-space according to settings of a plurality of second high-speed buffers in the second level of cache, wherein the plurality of second high-speed buffers are configured to store atomic tensor blocks obtained by splitting the tensor sub-blocks and intermediate operation results obtained by performing a convolution operation on the atomic tensor blocks.

10. The method of claim 6, wherein the determining the coefficient values of the splitting coefficients by minimizing the cost function comprises:
determining search strides used for searching the search space, wherein the search strides comprise search strides Δn, Δh, Δw, Δc, and Δco respectively associated with N, H, W, C, and Co dimensions; and
using a search algorithm to search in the search space with the search strides to determine the coefficient values of the splitting coefficients that minimize the cost function.

11. The method of claim 10, wherein the tensor information comprises a count of master computing units of the on-chip system participating in the convolution operation, a count of computing sub-units in each of the master computing units, and a data volume size of loading from the off-chip system and achieving the highest bandwidth utilization, and in determining the search strides, the method comprises determining the search strides at least based on the count of the master computing units, the count of the computing sub-units, and the data volume size.

12. The method of claim 11, wherein the tensor information further comprises storage formats and data layout information of the input feature map tensor and the convolution kernel tensor in the off-chip system, wherein the storage formats comprise data storage in a corresponding leading dimension, and the data layout information comprises placement information of a tensor in each dimension,
wherein in determining the search strides, the method further comprises:
determining the search strides according to the storage formats and layout information of the input feature map tensor and the convolution kernel tensor.

13. The method of claim 7, further comprising:
using a plurality of candidate convolution algorithms to obtain a plurality of pieces of search space, wherein each candidate convolution algorithm is associated with corresponding search space;
obtaining a cost function value associated with each of the candidate convolution algorithms according to the plurality of pieces of search spaces and the cost function; and
by comparing a plurality of cost function values, selecting a candidate convolution algorithm with a minimum cost function value from the plurality of candidate convolution algorithms as a predetermined convolution algorithm.

14. A device for optimizing a convolution operation of an on-chip system, the device comprising:
a processor; and
a memory, on which a program instruction for optimizing the convolution operation of the on-chip system is stored, wherein when the program instruction is performed by the processor, the device performs steps comprising:
receiving tensor information of an input feature map tensor and a convolution kernel tensor that are to be split to perform the convolution operation, wherein the input feature map tensor and the convolution kernel tensor are multi-dimensional tensor data, and the tensor information at least comprises size information of the input feature map tensor in each of its dimensions, size information of the convolution kernel tensor in each of its dimensions, and respective data sizes of the input feature map tensor and the convolution kernel tensor;
constructing a cost function at least based on the tensor information and splitting coefficients, wherein the cost function is used to determine the cost of transferring tensor data between the on-chip system and an off-chip system to perform the convolution operation on the on-chip system, and the splitting coefficients are used to split the input feature map tensor and the convolution kernel tensor on respective one or more dimensions of the input feature map tensor and the convolution kernel tensor; and
determining coefficient values of the splitting coefficients by minimizing the cost function to use the coefficient values to perform splitting on the respective one or more dimensions of the input feature map tensor and the convolution kernel tensor.

15-18. (canceled)

19. The device of claim 14, wherein both the input feature map tensor and the convolution kernel tensor are three-dimensional tensor data, or both the input feature map tensor and the convolution kernel tensor are four-dimensional tensor data, wherein when both the input feature map tensor and the convolution kernel tensor are the three-dimensional tensor data, the splitting coefficients are used to split the input feature map tensor and the convolution kernel tensor in one or more of three dimensions, and when both the input feature map tensor and the convolution kernel tensor are the four-dimensional tensor data, the splitting coefficients are used to split the input feature map tensor and the convolution kernel tensor in one or more of four dimensions.

20. The device of claim 19, wherein both the input feature map tensor and the convolution kernel tensor are the four-dimensional tensor data, wherein the input feature map tensor is a four-dimensional tensor of N*H*W*C, and the convolution kernel tensor is a four-dimensional tensor of C*Kₕ*K_{w}*Co, wherein the N dimension represents a count of input feature maps, the H dimension represents a height of the input feature maps, the W dimension represents a width of the input feature maps, the C dimension represents a channel count of the input feature maps, the Kₕ dimension represents a height of a convolution kernel, the K_{w} dimension represents a width of the convolution kernel, and the Co dimension represents a channel count of output feature maps.

21. The device of claim 20, wherein splitting coefficients of the input feature map tensor and the convolution kernel tensor are N_{b}*H_{b}*W_{b}*C_{b} and C_{b}*Kₕ*K_{w}*Co_{b}, wherein the N_{b}, H_{b}, W_{b}, C_{b}, and Co_{b} represent splitting coefficients corresponding to the N, H, W, C, and Co dimensions respectively, and the steps further comprise:
constructing the cost function at least based on the tensor information and the splitting coefficients N_{b}, H_{b}, W_{b}, C_{b}, and Co_{b}; and
determining coefficients values of the splitting coefficients N_{b}, H_{b}, W_{b}, C_{b}, and Co_{b} by minimizing the cost function to split the input feature map tensor and the convolution kernel tensor into corresponding multiple tensor blocks respectively based on the coefficient values.

22. The device of claim 21, wherein constructing the cost function further comprises constructing the cost function based on bandwidth utilization coefficients of leading dimensions of the input feature map tensor and the convolution kernel tensor, wherein the leading dimension of the input feature map tensor is one of the H_{b}, W_{b}, and C_{b} and the input feature map tensor is arranged on the off-chip system in terms of its leading dimension, the leading dimension of the convolution kernel tensor is one of the C_{b} or Co_{b} and the convolution kernel tensor is arranged on the off-chip system in terms of its leading dimension, and the bandwidth utilization coefficient equals to a ratio between an equivalent bandwidth when tensor blocks are loaded from the off-chip system at a predetermined data length and a total bandwidth between the on-chip system and the off-chip system.

23. The device of claim 14, wherein in determining the coefficients values of the splitting coefficients by minimizing the cost function, the steps comprise creating search space used for minimizing the cost function to determine the coefficients values of the splitting coefficients by using the search space.

24. A non-transitory computer-readable medium having stored thereon computer-readable instructions that, when executed by a processor, cause the processor to execute a method for optimizing a convolution operation of an on-chip system, wherein the method is implemented by one or a plurality of processors and comprises:
receiving tensor information of an input feature map tensor and a convolution kernel tensor that are to be split to perform the convolution operation, wherein the input feature map tensor and the convolution kernel tensor are multi-dimensional tensor data, and the tensor information at least comprises size information of the input feature map tensor in each of its dimensions, size information of the convolution kernel tensor in each of its dimensions, and respective data sizes of the input feature map tensor and the convolution kernel tensor;
constructing a cost function at least based on the tensor information and splitting coefficients, wherein the cost function is used to determine the cost of transferring tensor data between the on-chip system and an off-chip system to perform the convolution operation on the on-chip system, and the splitting coefficients are used to split the input feature map tensor and the convolution kernel tensor on respective one or more dimensions of the input feature map tensor and the convolution kernel tensor; and
determining coefficient values of the splitting coefficients by minimizing the cost function to use the coefficient values to perform splitting on the respective one or more dimensions of the input feature map tensor and the convolution kernel tensor.
